(19) United States
(12) Patent Application Publication
(10) Pub. No.: US 2010/0230964 A1
(43) Pub. Date: Sep. 16, 2010

(54) Adaptive Nacelle Support Systems, and Methods, for Wave Energy Conversion

(76) Inventor: George A. Sachs, Sylvan Lake, MI (US)

Correspondence Address: George Sachs, 1845 Woodland, Sylvan Lake, MI, 48320, US

(21) Appl. No.: 12/401,607

(22) Filed: Mar. 10, 2009

(51) Int. Cl. H02P 9/04

(52) U.S. Cl. 290/42

(57) ABSTRACT

A system and method for supporting a wave-energy generation device that features an adaptive floating platform, which under computer control, can autonomously adjust at least one of its design elements in order to increase or decrease the responsiveness of the floating wave-energy support system to varying wave-energy conditions. By, thereby, being able to tune the wave-energy support platform for varying wave conditions, a greater amount of power can be produced from a wave energy conversion generator selected to be compatible with the adaptive floating platform.

### REFERENCE TO RELATED APPLICATIONS

This application claims priority of U.S. provisional patent application Ser. No. 60/035,262 filed Mar. 10, 2008, the entire contents of which are incorporated herein by reference.

### STATEMENT REGARDING FEDERALLY SPONSORED RESEARCH

N.A.

### FIELD OF INVENTION

This invention relates, in general, to a system and method for providing improved floating platforms for use in the generation of power from wave motion on a body of water and more specifically for allowing such floating platforms to adaptively reconfigure themselves so as to maximize the amount of power that such wave energy generation devices can provide, when installed on such an adaptive platform.

### BACKGROUND OF THE INVENTION

In today's energy starved world, extensive efforts are being made to produce energy, and in particular, electrical power from naturally occurring phenomena, such as solar radiation, the winds and ocean waves. This latter phenomenon has generated particular interest among scientists because of the enormous potential inherent in wave energy. While there have been a large number of proposed devices for converting water wave energy into useful power, based on harnessing the motion of free-floating buoys, these do not provide much innovation with regards to the basic floating structures or buoys upon which they depend. Therefore, such devices are limited in their ability to optimally or maximally generate power due to their non-adaptive and static design, which limits their responsiveness to changing wave conditions, and predisposes them to having preferred oscillation frequencies. It would therefore be highly desirable to provide one or more adaptive platforms and systems that could allow existing and future ocean-energy devices the ability to more broadly adjust to changing wave conditions. Some types of wave energy generators that could be accommodated within such an adaptive wave energy support system include those based on the gyroscopic wave energy generation principle known as the GyroGen, described in Sachs, U.S. Pat. No. 4,352,023. Also suitable for use with this invention would be devices based on the principle of pendulum motion, such as described in U.S. Pat. Nos. 4,843,250, 4,438,343, 7,472,677, 7,456,512, 7,436,082, and 7,105,939, and those based on the concept of a sliding mass, such as those described in patents by Konotchick, U.S. Pat. No. 5,347,186, and French, Patent No. U.S. 2004/0007880A1. Of coarse the invention could also be used with any other wave energy conversion scheme that would preferably allow the generating mechanism to be isolated from direct contact with the ocean environment. The invention claimed herein would therefore not be limited to methods and systems for wave energy generation cited above, but could also be applied to future innovations in this field that could benefit from such an invention.

### SUMMARY OF INVENTION

This invention is directed to increasing the amount of power that can be delivered by a variety of wave energy conversion devices based on conversion of the forced motion of floating structures. In particular this invention is directed towards the problem of providing maximal coupling and tuning of wave energy devices to widely varying wave conditions and more specifically to the problem of efficient water wave energy capture. FIGS. 1-4 clearly illustrate the concepts underlying the preferred embodiments of these adaptive methods and systems, which are described in greater detail herein. It is the intent of the present invention to provide methods and systems which will allow for any type of suitable wave energy transducer, that is preferably capable of being isolated from the ocean environment, to more optimally and maximally generate power than would normally be possible using ordinary methods of non-adaptive static containment and support structures, more generally referred to as fixed buoy type mountings.

### BRIEF DESCRIPTION OF THE DRAWINGS

FIG. 1 shows one nacelle support system wherein a sealed nacelle containing a suitable wave energy transducer is supported by two independent hollow floats in the form of pontoons, which together with an adaptive scissors type separation mechanism, forms a catamaran style floating power station.

FIG. 1a is the view from below the device of FIG. 1.

FIG. 2 shows a similar nacelle support system wherein the sealed nacelle is again supported by two independent pontoon type hollow floats, which are coupled with the nacelle and each other by use of movable pistons or bellows.

FIG. 2a is the view from below the device of FIG. 2.

FIG. 3 shows a nacelle support system comprising a plurality of adjustable hollow floats, which are arranged symmetrically about the central nacelle. The hollow floats can be made to increase or decrease their radial separation distance relative the central nacelle.

FIG. 3a is a view from below the device of FIG. 3

FIG. 4 shows a nacelle support system having a plurality of concentrically situated circular floats that are coupled by use of flexible and elastic tubular spacers. The separation distance between floats is fixed in this configuration.

### DESCRIPTION OF REFERENCE NUMERALS

1. Wave energy nacelle containing a wave energy generation mechanism
2. Float
3. Scissor separation mechanism
4. Flexible ballast hose
5. Flexible piston hose
6. Keel/Centerboard
7. Elongated subsurface hull
8. Subsurface righting weight
9. Separation Piston/Bellows
10. Adaptive rod positioner and hub
11. Rod positioner piston
11a. Piston Cylinder
12. Primary structural support frame
12a. Corner bushing
13. Floatation extension rod
14. Rotatable slide bushing
15. Rotatable bushing
16. Flexible connector

### DETAILED DESCRIPTION OF THE INVENTION

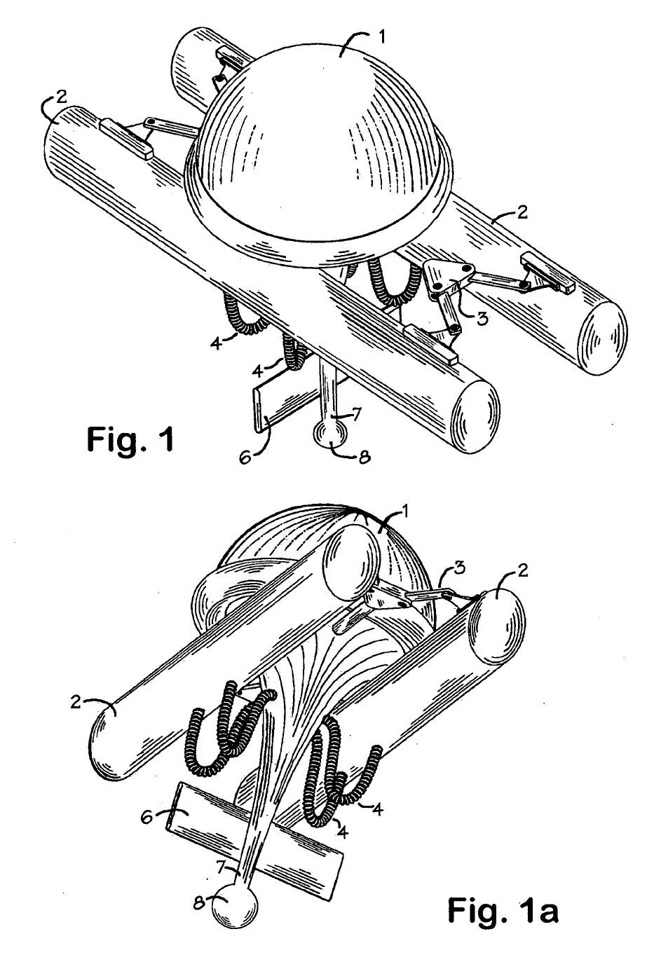

With reference to attached FIGS. 1-4 and the above nomenclature and numbering scheme, each nacelle support system and method will be herein described. We first can see by way of FIG. 1 that one such preferred method for adaptive support of a nacelle containing an energy conversion device is by utilization of dual independent floatation members 2 that are affixed to a central buoy comprising the wave energy nacelle 1, elongated subsurface hull 7, an optionally attached keel or centerboard 6 that is mounted orthogonal to the main axis of each float, and an optionally attached subsurface righting weight 8. The floats 2 are attached to the central nacelle 1 by means of a scissor action positional adjuster 3 that is responsive to commands from onboard sensors and a control computer located within nacelle 1. Under control of said sensors and computer, the scissor adjusters can be made to either further separate or bring closer together floats 2, so that the overall structure consisting of nacelle 1 and floats 2 is optimally, or more precisely, maximally responsive to waves impinging on said structure and so as to allow the wave energy converter enclosed within nacelle 1 to obtain maximal energy output at all times. This condition would generally be obtained when the separation distance between floats 2 are so adjusted as to be proportional with the wavelength of the impinging waves, though not necessarily equal to them. Therefore for larger waves having a greater wavelength, the separation distance of floats 2, would be greater than for waves having shorter wavelengths, thereby helping to maintain the oscillation amplitude of nacelle 1 at a maximum. The nacelle support system is further provided with a mechanism for adjusting the ballast of floats 2, by way of a pumping system internal to nacelle 1 and which can either fill or empty floats 2 by means of flexible hoses 4. By increasing the weight in the floats 2, the nacelle support system can alter its center of gravity and center of buoyancy, as well as its overall mass, so as to allow the wave energy generator to produce more power, while also allowing the entire system to survive more intense wave conditions.

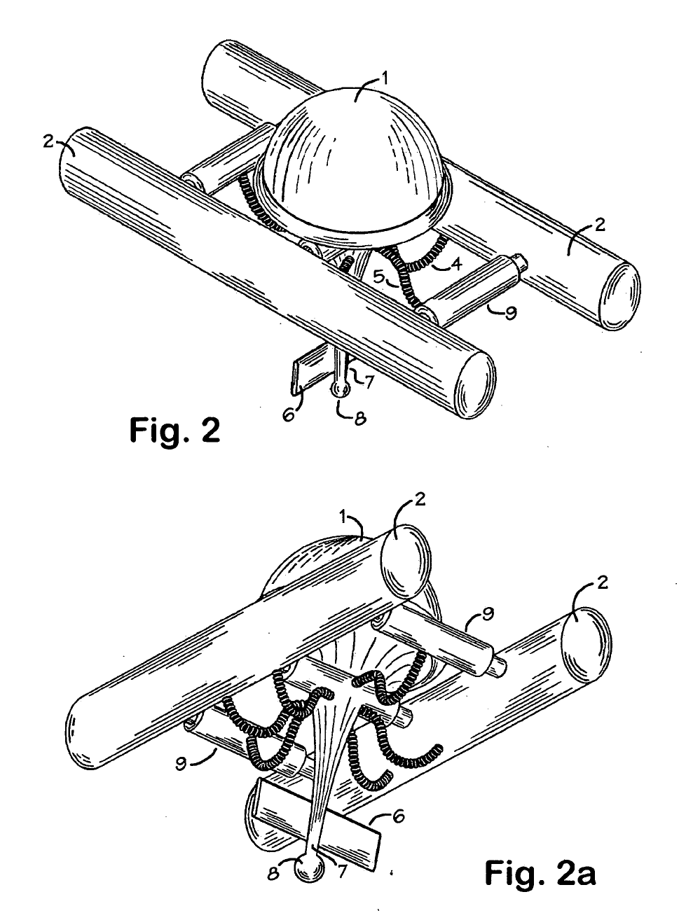

In FIG. 2 is shown a similar structural configuration wherein the scissor mechanism is replaced by a plurality of separation pistons/bellows 9, at least one of which is rigidly attached to the central buoy comprising structures 1,7,6,8 as described above. In addition to ballast hoses 4 there is also provided flexible hosing 5 to each separation piston 9 for the purpose of extending or retracting each piston using air pressure or hydraulic pressure. This system then operates in accordance with the principles described above wherein the separation pistons 9 can be made to move inwards or outwards by means of either air pressure or water pressure. This method of adaptive nacelle support also provides for increasing ballast in floats 2 as described above.

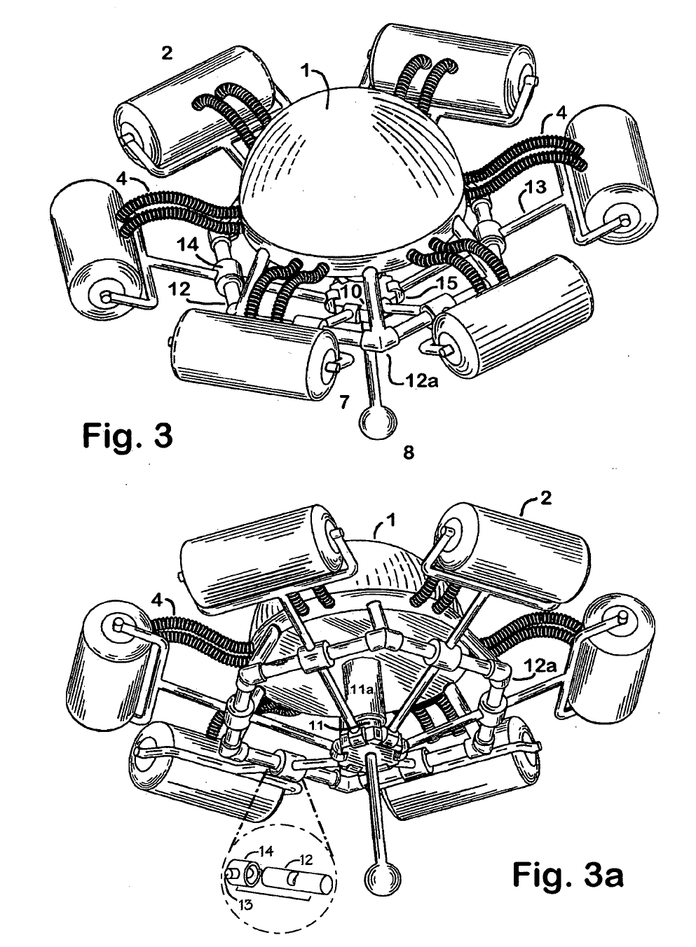

In FIG. 3 is shown yet another preferred embodiment of the present invention wherein floats 2 are now circularly configured about the centrally located nacelle 1 by means of a primary structural support frame 12 providing rotatable bushings 14 that allow connecting rods 13 to both slide in and out with respect to frame 12 as well as pivot about said frame as dictated by a centrally located positioning hub 10 to which each connecting rod 13 is pivotally attached by means of rotatable bushings 15. The central hub 10 is then movable in an up and down manner with respect to nacelle 1 by means of a piston 11 and cylinder 11a attached to nacelle 1. The elongated subsurface hull 7 can then be replaced with a rod 7 and an optional righting weight 8. As the positioning hub 10 is moved in response to commands from sensors and the control computer in the manner described above, the floats 2 will respond by moving either closer or further from nacelle 1, again providing an adaptive means to allow the capture of a maximal amount of energy from each wave. In this configuration a centerboard is not used, as the purpose of the structure is to allow waves to impinge from all directions rather than the preferred direction in which the devices in FIGS. 1-2 are biased for. Alternatively, the rods comprising frame 12 can be allowed to rotate about frame 12a corners using bushings mounted within frame corners 12a. In another embodiment of this invention piston 11 could be replaced by a ball screw driven mechanism within cylinder 11a without deviating from the intent of the invention.

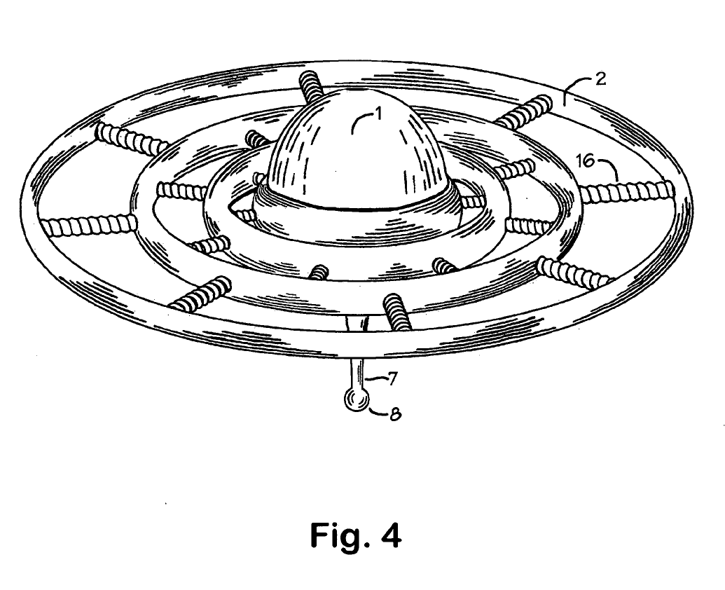

FIG. 4 depicts yet another preferred embodiment of the present invention whereby concentric and preferentially circular floats 2 are attached to nacelle 1 by means of flexible and spring loaded couplings 16. The spring constants can thereby be adjusted under computer control to achieve optimal wave coupling depending on varying wave conditions. Of course the circular floats could also be replaced with polygonally shaped floats without deviating from the overall intent of the invention.

In all embodiments of the present invention the nacelle support system will be fixed to the ocean floor using conventional mooring lines and energy would be transmitted to shore using underwater power transmission cables.

### OBJECTS AND ADVANTAGES

Accordingly, the reader will see that the present invention is directed to providing a system and method for effectively supporting various wave energy generation devices so as to increase their energy generation output over a greater range of wave frequencies and wavelengths. In so doing this invention will increase energy production thereby reducing the cost of delivering such energy on a per kilowatt basis. A further advantage of this invention is that it provides methods to autonomously reduce the responsiveness of the floatation platform to intense wave conditions and thereby increasing the robustness of the wave energy generator and providing protection from damage that could normally occur because of such intense wave conditions. Several methods for accomplishing this goal are provided including adjustment of the floatation platform footprint and increasing or decreasing the ballast within the platform floats. A further advantage of the present invention is that the overall weight and dimensions of the platform can be reduced to allow for easier transport while allowing weight to be substantially increased at sea, using ballast water. Yet another advantage of the present invention is that it allows the wave energy generator that will be incorporated within the wave energy nacelle to be of a more compact design, with a prime example of one such compact device being the Sachs-GyroGen.

1. A wave energy generation support platform comprising a plurality of independent floats, which are adaptively attached to, at least one nacelle, wherein said nacelle houses a wave energy conversion means indirectly harness water wave energy without need for direct contact with the water waves carrying said water wave energy and where the distance of said independent floats from said, at least one nacelle, may be adjusted by means of an adaptive control system, in order to maximize said water wave energy to said nacelle.

2. The adaptive nacelle support platform system of claim 1 wherein said wave energy conversion means located within said nacelle includes devices utilizing pendulums to convert said water wave energy into mechanical, and electrical energy.

3. The adaptive nacelle support platform system of claim 1 wherein said wave energy conversion means located within said nacelle includes devices utilizing gyroscopes to convert said water wave energy into mechanical, and electrical energy.

4. The adaptive nacelle support platform system of claim 1 wherein said wave energy conversion means located within said nacelle includes devices utilizing sliding power transducers to convert said water wave energy into mechanical, and electrical energy.

5. The adaptive nacelle support platform system of claim 1 wherein said adaptive control system of said independent floats, is provided by an autonomous on-board control computer, powered by said wave energy conversion means .

6. The adaptive nacelle support platform system of claim 1, further including an optional subsurface stabilizing keel, and an optional subsurface righting weight.

7. A wave energy generation support platform system comprising at least two pontoon shaped independent floats, which are adaptively attached to, at least one nacelle, wherein said nacelle houses a wave energy conversion means for indirectly harnessing water wave energy without need for direct contact with water waves carrying said water wave energy, and where the distance of said independent pontoon shaped floats from said, at least one, nacelle may be adjusted by means of an adaptive control system, in order to maximize delivery of said water wave energy to said nacelle.

8. The adaptive nacelle support platform system of claim 7, wherein said pontoon shaped independent floats are adaptively attached to said, at least one, nacelle by means of a scissor mechanism that allows said pontoon shaped floats to be separated by varying distances under computer control.

9. The adaptive nacelle support platform system of claim 7, wherein said pontoon shaped independent floats are adaptively attached to said, at least one, nacelle by means of a plurality of linearly expandable couplers taken from the set of telescoping pistons, telescoping bellows, and screw driven telescoping extension rods, and wherein said telescoping pistons, and telescoping bellows are driven pneumatically.

10. The adaptive nacelle support platform system of claim 7, wherein said pontoon shaped independent floats are adaptively attached to said nacelle by means of a plurality of linearly expandable couplers taken from the set of telescoping pistons, telescoping bellows, and screw driven telescoping extension rods, and wherein said telescoping pistons, and telescoping bellows, are driven hydraulically.

11. The adaptive nacelle support platform system of claim 7 wherein said wave energy conversion means, located within said nacelle, further includes devices utilizing pendulums to convert said water wave energy into mechanical, and electrical energy.

12. The adaptive nacelle support platform system of claim 7 wherein said wave energy conversion means, located within said nacelle, further includes devices utilizing gyroscopes, to convert said water wave energy into mechanical, and electrical energy.

13. The adaptive nacelle support platform system of claim 7 wherein said wave energy conversion means, located within said nacelle, further includes devices utilizing sliding linear power transducers, to convert said water wave energy into mechanical, and electrical energy.

14. The adaptive nacelle support platform system of claim 7, further including an optional subsurface stabilizing keel

15. The adaptive nacelle support platform system of claim 7, further including an optional an optional subsurface righting weight.

16. A wave energy generation support platform system comprising a plurality of circularly arranged, and independent, floats, which are adaptively attached to, at least one nacelle, wherein said nacelle houses a wave energy conversion means for indirectly harnessing water wave energy without need for direct contact with water waves carrying said water wave energy.

17. The adaptive nacelle support platform system of claim 16 wherein the distance of said, independent, circularly arranged, floats from said, at least one nacelle, may be adjusted by means of an adaptive control system, in order to maximize said water wave energy that can be delivered to said nacelle.

18. The adaptive nacelle support platform system of claim 16 wherein the freedom of relative movement of said, independent, circularly arranged, floats from said at least one nacelle, may be adjusted by means of an adaptive control system, in order to maximize said water wave energy that can be delivered to said nacelle.

19. The adaptive nacelle support platform system of claim 16, further including an optional subsurface stabilizing keel.

20. The adaptive nacelle support platform system of claim 16, further including an optional subsurface righting weight.
